(19) United States
(12) Patent Application Publication
(10) Pub. No.: US 2006/0098423 A1
(43) Pub. Date: May 11, 2006

(54) Reduced-volume portable illumination unit using diffusion films

(75) Inventors: David Dean, Commerce Twp., MI (US); Richard Drumsta, Walled Lake, MI (US); Fred Yacobelli, Highland, MI (US)

Correspondence Address: Rubinstein Law Group, Professional Corporation;David Bogart Dort, 1700 Diagonal Road, Suite 300, Alexandria, VA, 22314, US

(73) Assignee: Pursuit Engineering LLC, Milford, MI (US)

(21) Appl. No.: 11/264,391

(22) Filed: Nov. 2, 2005

Related U.S. Application Data
(60) Provisional application No. 60/522,747, filed on Nov. 2, 2004.

(51) Int. Cl. F21L 4/00

(52) U.S. Cl. 362/157

(57) ABSTRACT

The present invention provides for a portable light diffusion unit that comprises a casing 10, one or more laser diodes 2 and a series of diffusion screens 8. The diode(s) direct a concentrated beam of light 3 at an approximate perpendicular angle to the series of diffusion screens and the diffusion screens diffuse the concentrated beam of light into a diffuse beam of light.

### CROSS REFERENCE TO RELATED APPLICATIONS

This application claims priority to U.S. provisional application 60/522,747, filed Nov. 2^{nd}, 2004, by David A. Dean, et al, which is incorporated by reference for all purposes.

### BACKGROUND OF THE INVENTION

Laser diode illumination systems function by dispersing a single point laser light source into a diffuse light beam. This is accomplished by passing the laser light beam through various screens, such as collimators and diffuser lenses until the tight beam of light is spread into a sufficiently broad beam. For most applications, it is desirable to spread the light beam evenly; however, for some applications an uneven spreading of the beam may be desired. Diffusers of the prior art are typically lenses, which can be large, fragile and difficult to manufacture.

A significant problem with laser diode illumination systems is that the equipment needed to convert a strong laser light source into a diffuse light beam is considerable. Efforts have been made to reduce the size of the laser diode illumination systems, such as in U.S. Pat. No. 6,429,429 B1. However, the systems remain relatively large.

By reducing the size of the illumination sources, industries such as night vision can become more portable and efficient. Current portable night vision illumination devices produce relatively low illumination levels, which in turn limits night vision equipment to narrow fields of view with low resolution.

What is needed is a laser diode illumination device that is smaller and more portable, also known as having a reduced footprint, without impeding illumination quality.

### SUMMARY OF THE INVENTION

With the foregoing in mind, methods and apparatuses consistent with the present invention, which, inter alia, facilitates illumination of an area with a laser diode light source that has been diffused by a portable light diffusion unit. The light diffusion unit is encased in a thermally conductive material that can be approximately 5 inches (12.5 cm) long, 3.0 inches (7.5 cm) wide and 2 inches (5 cm) high and approximately 5 pounds (0.9 kg), although sizes and weight will vary depending on the application. Within the unit, one or more laser diode light sources direct a concentrated light beam at series of diffusion screens. The concentrated beam of light is shone directly or at a near perpendicular angle to the series of diffusion screens which are aligned parallel to one another.

As the light passes through the diffusion screens, it is spread at a predetermined angle. Although the concentrated beam of light can be spread through as little as one or as many as six or more screens, particular embodiments use 2-4 screens and specific embodiments use only two.

The intensity of illumination is directly related to the power of the laser diode and the efficiency of the system. Laser diodes in the 10-20 watt range will typically be used, although wattages outside this range can also be used depending on the application. The efficiency of the system depends in a large part on the quality of the parts used; however an efficiency of 85% is readily obtainable. The frequency of the illuminating light can also be varied, but in certain embodiments is in the 800-950 nm range.

These and other objects, features, and advantages in accordance with the present invention provide particular embodiments with a portable light diffusion units that comprises a casing, one or more laser diodes and a series of diffusion screens. The diode(s) direct a concentrated beam of light at an approximate perpendicular angle to the series of diffusion screens and the diffusion screens diffuse the concentrated beam of light into a diffuse beam of light.

In another embodiment, the present invention provides for a night vision illumination device with a reduced footprint that comprises a casing that is made predominately out of copper, with a heat sink that has mounted on it a non-collimated laser diode that produces light in the 800-950 nm range, and in particular at 808 nm, which produces a concentrated beam of light. Two holographic diffusion screens are aligned in a series at an approximately perpendicular angle to the laser diode. The series of diffusion screens diffuse the concentrated beam of light into a diffuse beam of light. The light then passes through a protective lens out of the casing. The laser diode 7-20 watts is positioned at least 2-3 inches (5-7.5 cm) from the nearest of the holographic diffusion screens. The greater the power of the laser, the greater the distance it should travel before contacting the first diffusion screen. In total, the diffuse beam of light has a spread of between 30°-65°. This diffusion may favor horizontal over vertical, especially since the concentrated beam of light from a non-collimated laser diode tends to have a greater diffusion in the horizontal than in the vertical.

Another embodiment the present invention provides for a remotely operated robot with night vision capabilities that comprise one or more camera system(s) and one or more night vision illumination system(s). The night vision illumination system comprises one or more laser diode(s) that produces a concentrated light beam in the 800 to 950 nm range. This beam is directed at a series of diffusion screens, where the series of diffusion screens diffuse the concentrated beam of light into a diffuse field of light and an area is illuminated for one or more cameras. The night vision illumination system may be integrally formed with the robot or it may be reversibly mounted to the robot.

### BRIEF DESCRIPTION OF THE FIGURES

The invention is explained in more detail by way of example with reference to the following drawings:

FIGS. 1A, 1B and 1C illustrate a portable light diffusion unit with two diffusion screens.

FIG. 2 illustrates an embodiment using two laser diodes.

FIG. 3 illustrates an embodiment where the series of diffusion screens are not optimally positioned.

### DETAILED DESCRIPTION OF THE INVENTION

The present invention provides for a portable illumination device with a reduced footprint size. Particular embodiments of the invention are useful in illuminating in conjunction with night vision technologies. Laser diodes are an excellent source of illumination for a variety of different spectrums, particularly infrared. Unfortunately the laser diode produces a very tightly beamed light, which essentially over-illuminates small areas.

The present invention diffuses the laser diode light beam so that a much larger area can be thoroughly illuminated than would otherwise be possible with laser diode illumination sources. The spreading of the light beam is controlled by a series of diffusion screens. The size of the laser light diffuser is reduced in comparison to that of the prior art, and this is in part accomplished by using a limited number of relatively small diffusers.

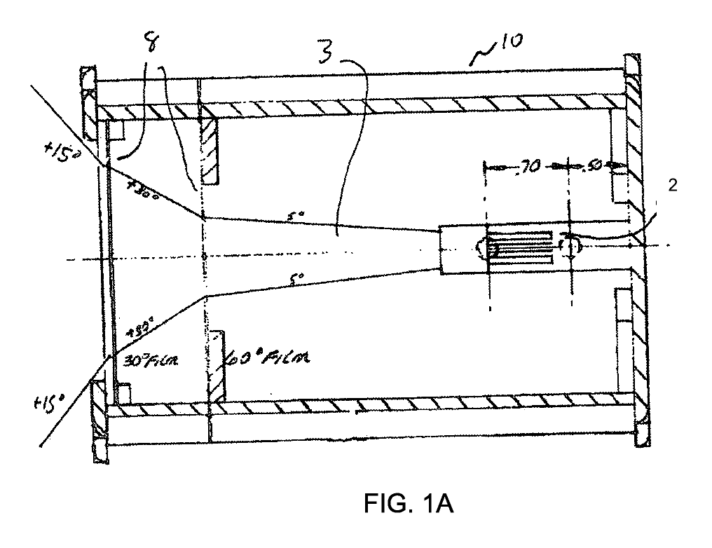

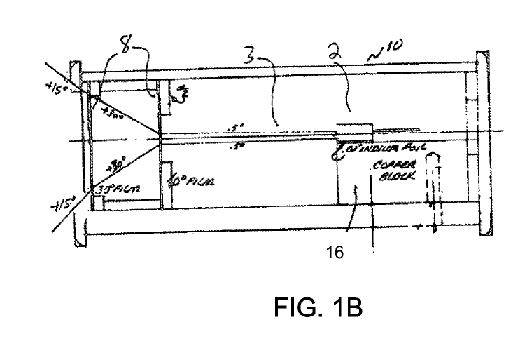

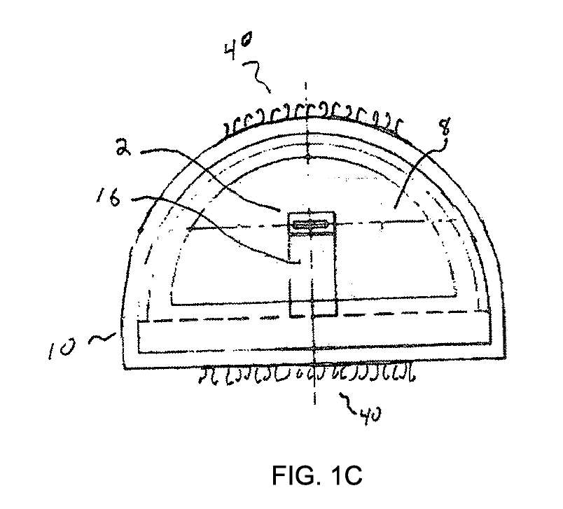

Referring to FIGS. 1A, 1B and 1C, an embodiment of the present invention is illustrated where two diffusion screens 8 are used to diffuse a concentrated beam of light 3 from a laser diode 2. FIG. 1A is a cutaway top view. FIG. 1B is a cutaway side view and FIG. 1C is an end-on front view. When a single laser diode 2 light source is being used, the diode is positioned approximately perpendicular to the center of the series of diffusion screens 8. When multiple laser diodes are being used, the positioning of the diodes may be varied slightly to accommodate the plurality of diodes.

The concentrated beam of light 3 produced by the laser diode is shone into a first and then a second diffusion screen 8. The spread of the light as it passes through the diffusion screen can be varied depending on the application. The embodiment shown uses a 60° film followed by a 30° film. The film spreads the light half of its rating to either side of center. For instance, the 60° film spreads the light an additional 30° to either side and the 30° film spreads the light to an additional 15° to either side. The spreading is cumulative so that the light is spread by 45° to either side upon exiting the second diffuser screen in addition to the spreading of light before it interacts with the diffuser screen.

For most applications, the diffuser screen spreads the light in an even manner, although in some applications an uneven diffusing of the light may be desirable, such as favoring horizontal spreading over vertical. Polycarbonate films are particular embodiments of diffusion screens used with the present invention. One type of polycarbonate file, known as a holographic diffuser, spreads the light in a uniform manner without changing its frequency and without a large impact on the net illumination. Holographic diffusers are supplied by POC™. In addition to spreading the light evenly or not, exactly how the light is spread can vary depending on the application. Essentially a wider area of illumination can be spread in exchange for illumination distance and vice versa.

The laser diode 2 may be of a variety of types, such as Osram™ diode. In some embodiments, the light from the diode is non-collimating. Typical diodes project light as a tight rectangle. A non-collimating diode projects light as an expanding rectangle. The dimensions of the rectangle will vary depending on the application, as well as the internal geometries of the light diffusion unit. The FIG. 1 illustrations, for instance, show the concentrated beam of light expanding outwards at 5° to the left and right and 0.5° to the horizontal and vertical. In particular embodiments, the wavelength of the light produced by the diode does not change by being diffused by the light diffusion unit.

In the embodiment illustrated in FIG. 1, a single laser diode 2 is used. In other embodiments, a plurality of laser diodes can be used in close conjunction with one another. This plurality of laser diodes may be of the same frequency to produce a stronger projected light, or they may be of a variety of frequencies so that a diffuse light with a greater frequency range is produced.

In addition to this, specific color effects can be accomplished. These color effects may be accomplished by a second type of laser diode, or may be accomplished by flooding the unit with another type of light external to the illustrated light path. For example, in the 808 nm range discussed below, the light diffusion unit will illuminate an area with invisible light, however, a small amount of red spectrum visible light will also be produced. Since red lights have particular meanings in many industries, it may not be desirable to have the light diffusion unit shine red. A second visible light source can be added almost anywhere within the light diffusion unit. For example, green floods out the red glow and creates an 808 nm invisible light source that also shines green. Of course the second light source, unless emitted from a diode and forced through the illustrated pathway, will not illuminate in the same manner as the first.

Alternately, the plurality of laser diodes can be pulsed, so that diodes of the same frequency can produce a continuous stream of plane projected light, or at least continuous enough to the human eye or to the equipment monitoring the light diffuser unit. In this embodiment, the pulsing of the diodes reduces their heat output and also increases the life expectancy of the diodes. It is also possible that a light diffuser unit can function at a variety of different states, such that if a stronger light source is required, multiple diodes turn on simultaneously, while a more heat/energy/life conservative mode can be used in default that pulses the diodes. Additionally, the rate of the pulse between the diodes can be changed depending what is using the light diffuser as a light source. For instance, a camera might require more or less pulses of light to function optimally than would the human eye looking through goggles.

Efficiency, as used herein, refers to the total intensity of the light as emitted from the laser diode to the total intensity of the light emitted from the light diffusion unit. A holographic diffuser will reduce the overall efficiency of the light diffuser unit by 5-8%. Therefore optimizing the spread of the light with fewer light diffusers is preferable. However, sometimes additional light diffusers are added to improve the light spread so that the overall efficiency is optimized. Other components that reduce efficiency but improve the system as a whole may also be used. For example, putting a protective lens, such as a glass or acrylic lens, over the end of the unit may reduce efficiency by about 2-5%, but will provide protection for the diffusion screen and internal components.

In the embodiment illustrated, two diffusion screens are used to spread the light beam. As few as one or as many as six or more screens could alternately be used; however, a trade-off between efficiency and light diffusion has to be considered. With only one screen, the light may not be sufficiently scattered. However, with six screens, the overall efficiency of the unit will be reduced. Particular embodiments use 2-4 screens to balance diffusion versus efficiency.

In this embodiment, the casing 10 of the light diffuser is made with a rigid, thermally conductive material, such as aluminum or copper. The purpose of the casing 10 is two-fold. It provides protection to the instruments within and it diffuses heat. The internal surfaces need to be kept as clean and clear as possible, so the casing 10 should be air tight, and in some embodiments the casing should be filled with gasses that do not scatter the projected light 6. To aid in the diffusion of heat, the casing 10, may have a plurality of fins that further aid in the diffusion of heat without adding significant weight. However, for some embodiments, it may be desired to maintain a sleeker surface which can aid in the cleaning of the unit after it is exposed to hazardous conditions.

It may be desirable to attach the light diffusion unit to a surface, either permanently or removably. FIG. 1C illustrates Velcro™ lining 40 at the top of the casing 10 to removably attach the unit to an object.

The casing itself can be a closed system, in that it can be an air tight unit. This would prevent dust and other materials from collecting on the internal surfaces. However, a particular embodiment allows for the flow of air into the unit while filtering dust particles. Gortex™ seals are an example of a passive air filter that does not allow particle contaminants or water to enter.

The heat produced from the laser diode can further be dissipated in a number of different ways. One such way is to place the diode on a heat sink 16, such as a copper block. Although heat sinks will increase the weight of the light diffuser unit, there is a trade-off between weight and heat diffusion. This trade off is also dependent on the use of the light diffuser unit.

The heat sink itself might have an interface between itself and/or the diode and the casing. For example, indium foil can be placed between the diode and a copper block to improve dissipation. Also, other materials such as Wakefield Thermal Compound heat conductive grease can be used between the heat sink and the casing. Fans, both internal and external, can also be used. An internal fan would optimally blow on or near the laser diode, while an external fan would supply air to the internal space. In addition, thermal electric coolers or TE coolers can be used to move heat from the heat sink to the external housing for greater heat transfer.

To make a light diffusion unit effective, the light emitted from the laser diode 2 needs to travel a certain distance before contacting the first diffusion screen. This is because the light from the diode needs to travel a certain distance so that a proper spread is achieved. Also, the heat from the diode may damage some types of lenses. In addition, it should be noted that certain embodiments position the series of diffusion screens relatively close together and towards or at the end of the unit. This is in part due to the spreading of the light. If the light travels too far after being spread by a diffusion screen, it will contact the sides of the casing, reducing the efficiency of the system.

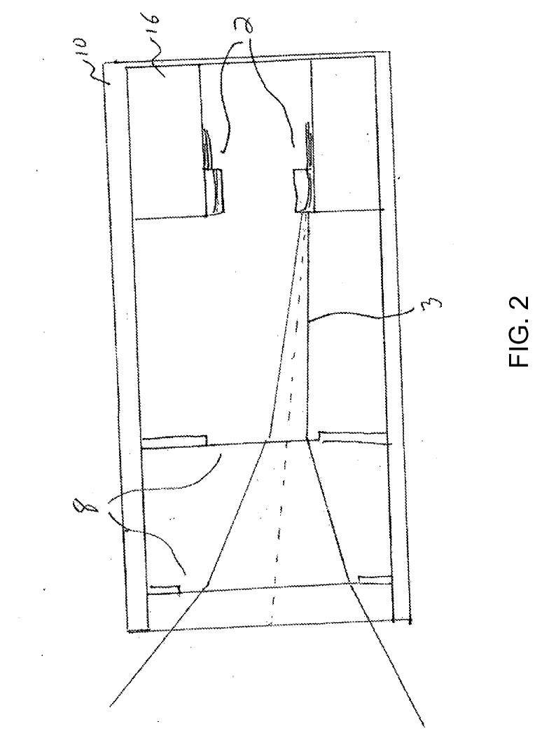

Referring to FIG. 2, a cut away side view of an embodiment using two laser diodes 2 is shown. In this embodiment, the laser diodes are placed on opposite sides of the casing 10, one on the bottom and one on the top. Since the diodes are not affected by gravity, they can be placed almost anywhere within the casing. As discussed, since two diodes are being used in this embodiment, they are positioned slightly off-center of the series of diffusion screens 8 such that the concentrated beam of light 3 strikes the first diffusion screen off of perpendicular.

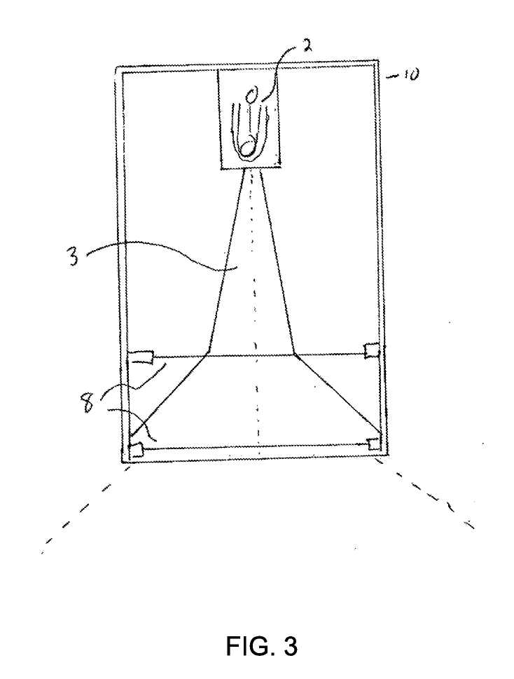

In FIG. 3, a top down view is seen of a poorly positioned series of diffusion screens 8. The concentrated beam of light strikes the first diffusion screen 8 and is spread at too great an angle, contacting the walls of the casing 10 before diffusing through the second screen. To correct this, the position of the laser diode or diffusion screens needs to be adjusted. In some embodiments, a reflective surface can be placed on the inner lining of the casing to help compensate for improper alignments.

The figures therefore have a sense of “up” for clarity. It would be apparent to one of ordinary skill in the art, however, that the configurations shown can be rotated at almost any angle to produce the same result. In fact, in some embodiments, it may be desirable to have the layout rotated 90° or 180°.

The dimensions of a portable light diffusion unit can vary, but in one embodiment, the external casing is approximately 5 inches (12.5 cm) long, 3.0 inches (7.5 cm) wide and 2 inches (5 cm) high. Similarly, the weight of the unit can vary, but in the embodiments illustrated is approximately 5 pounds (0.9 kg) if the casing is composed of copper, with approximately 6 ounces (0.17 kg) of that weight being the heat sink.

In the applications thus described, the invention has been applicable to any type of light. However, particular embodiments of the invention are used in conjunction with night vision technologies. Light in the range of approximately 800 to 950 nm is particularly useful for this application, though other ranges can also be used. For instance, 808 nm wavelength light is essentially invisible, although a dull red glow may still be seen. 915 nm wavelength light is even more invisible to the human eye. However, night vision equipment, such as a Watch™ CCD black and white camera, reads light at the 808 nm range better than the 915 nm range. So, at the 808 nm range, less power needs to be used, because a less intense beam at the 808 nm can be observed with the night vision equipment better than an equivalently powered beam at 915 nm. Therefore the wavelength can be varied depending on the corresponding night vision equipment. Some light diffusion units may even have multiple wavelength applications. Other wavelengths may be desirable in trying to make the light invisible to different types of animals for nighttime zoological studies.

As discussed, the present invention is suited to be used in a system with viewers, such as cameras and goggles, particularly when invisible light or night vision light frequencies are being used. This system is in turn particularly adaptable to remote viewing, such as closed circuit monitoring. In particular, mounting the present invention on devices such as robots used in search and rescue can be advantageous. Since these systems are operated remotely, the light diffusion unit needs only be able to produce light that can be registered by the viewing cameras.

The intensity of invisible light is measured in watts, which is directly a result of the power intensity of the laser diode being used. For example, an 808 nm laser diode that is powered at 10 to 20 watts will produce, at 85% efficiency; an 8.5 to 17 watts diffuse light. Diodes of 7-20 watts, and even greater, will typically be used with the present invention, although different intensity diodes can also be used. As the art of laser diodes increases, it is expected that upper watt ranges of the present invention will also increase.

Although the present invention is described as illuminating an area in front of the light source, whether with visible or invisible light, like any strong light source the area to the sides and behind the light source become illuminated as the light reflects off of the surfaces.

In one embodiment, the present invention provides for a portable light diffusion unit that comprises a casing, one or more laser diodes and a series of diffusion screens. The diode(s) direct a concentrated beam of light at an approximate perpendicular angle to the series of diffusion screens and the diffusion screens diffuse the concentrated beam of light into a diffuse beam of light.

In a related embodiment 2-4 diffusion screens are used, and in a particular embodiment two diffusion screens are used. In these embodiments, the first diffusion screen has a spread angle of between 40°-70°, and the second diffusion screen between 15°-45°. In particular embodiments, the spreads are 60° and 45° respectively. The diffusion screens can favor spreading in one direction versus another, such as horizontal over vertical. Particular types of diffusion screens include holographic film.

In related embodiments, the diodes may be non-collimated. A single laser diode may be used, or multiple diodes may be used. Embodiments of multiple diodes include the use of two diodes, which can pulse to provide a continuous stream of light, or which may be operated at the same time to produce a stronger beam of diffuse light. Particular light ranges for night vision include in the 800 to 950 nm range.

In other embodiments, the accessories to the casing include a heat sink that the laser diode is mounted on and a lens that protects the equipment inside of the casing. In particular embodiments, the casing is made of highly thermally conductive materials, such as copper.

In another embodiment the light diffusion unit is approximately 5 inches (12.5 cm) long, 3.0 inches (7.5 cm) wide and 2 inches (5 cm) high and approximately 5 pounds (0.9 kg), assuming that the casing is made predominately of copper. This size range can be varied without departing from the scope of the invention.

In another embodiment, the present invention provides for a night vision illumination device with a reduced footprint that comprises the following: a casing that is made predominately out of copper, and with a heat sink that has mounted on it a non-collimated laser diode that produces light in the 800-950 nm range, in particular at 808 nm, which produces a concentrated beam of light. Two holographic diffusion screens are aligned in a series and at an approximately perpendicular angle to the laser diode, where the series of diffusion screens diffuse the concentrated beam of light into a diffuse beam of light. The light then passes through a protective lens and out of the casing. The laser diode of 7-20 watts, is positioned at least 2-3 inches (5-7.5 cm) from the nearest of the holographic diffusion screens. The greater the power of the laser, the greater the distance it should travel before contacting the first diffusion screen. In total, the diffuse beam of light has a spread of between 30°-65°. This diffusion may favor horizontal over vertical, especially since the concentrated beam of light from a non-collimated laser diode tends to spread greater in the horizontal than the vertical.

In still another embodiment, the present invention provides for a remotely operated robot with night vision capabilities that comprise one or more camera system and one or more night vision illumination system. The night vision illumination system comprises one or more laser diodes that produce a concentrated light beam in the 800 to 950 nm range. This light beam is directed at a series of diffusion screens, that diffuse the concentrated beam of light into a diffuse beam of light and an area is illuminated for one or more cameras. The night vision illumination system may be integrally formed with the robot or it may be reversibly mounted to the robot.

Although the present invention is referred to as being portable, or having a reduced footprint which means a small size, this is descriptive of its size and weight in contrast with the laser diode illumination devices of the prior art. The present invention may be permanently affixed or integral with a variety of systems or objects without departing from the scope of the present invention.

It is further important to note that although the present invention is often referred to as being usable with or as a night vision system; the term night vision does not confine the present invention to being used only at night or in the dark. Cameras and other viewing equipment can be used that are not susceptible to being blinded by daylight conditions. Therefore, night vision refers to systems that can operate in the dark as well as in the light, and in many applications can function equally well in the dark.

While specific embodiments of the invention have been described in detail, it will be appreciated by those skilled in the art, that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A portable light diffusion unit comprising:
a casing;
at least one laser diode; and
a series of diffusion screens;
wherein said at least one laser diodes direct a concentrated beam of light at an approximate perpendicular angle to said series of diffusion screens;
wherein said series of diffusion screens diffuse said concentrated beam of light into a diffuse beam of light.

2. The portable light diffusion unit of claim 1, wherein 2-4 diffusion screens are used in said series of diffusion screens.

3. The portable light diffusion unit of claim 2, wherein 2 diffusion screens are used in said series of diffusion screens.

4. The portable light diffusion unit of claim 3, wherein a first diffusion screen in said series of diffusion screens has a spread angle of between 40°-70°.

5. The portable light diffusion unit of claim 3, wherein a second diffusion screen in said series of diffusion screens has a spread angle of between 15°-45°.

6. The portable light diffusion unit of claim 3, wherein a first diffusion screen in said series of diffusion screens has a spread angle of 60° and a second diffusion screen in said series of diffusion screens has a spread angle of 45°.

7. The portable light diffusion unit of claim 1, wherein said at least one laser diode consists of a single laser diode.

8. The portable light diffusion unit of claim 7, wherein said single laser diode is non-collimated.

9. The portable light diffusion unit of claim 1, wherein said at least one laser diode consists of two laser diodes.

10. The portable light diffusion unit of claim 9, wherein said two laser diodes pulse to provide a continuous stream of light.

11. The portable light diffusion unit of claim 9, wherein said two laser diodes are operated at the same time to produce a stronger beam of diffuse light.

12. The portable light diffusion unit of claim 1, wherein said at least one laser diode produces light in the 800 to 950 nm range.

13. The portable light diffusion unit of claim 1, wherein said at least one laser diode is mounted to a heat sink.

14. The portable light diffusion unit of claim 1, wherein said casing has a lens that said diffuse beam of light is projected through.

15. The portable light diffusion unit of claim 1, wherein said casing is predominately copper.

16. The portable light diffusion unit of claim 1, wherein said light diffusion unit is approximately 5 inches (12.5 cm) long, 3.0 inches (7.5 cm) wide and 2 inches (5 cm) high and approximately 5 pounds (0.9 kg).

17. The portable light diffusion unit of claim 1, wherein said diffusion screens are holographic films.

18. A night vision illumination device with a reduced footprint comprising:
a casing that is made predominately out of copper;
a 7-20 watt non-collimated laser diode that produces light in the 800-950 nm range to produce a concentrated beam of light;
a heat sink that said laser diode is mounted to;
two holographic diffusion screens aligned in a series and at an approximately perpendicular angle to said laser diode, wherein said series of diffusion screens diffuse said concentrated beam of light into a diffuse beam of light; and
a lens;
wherein said laser diode is positioned at least 2-3 inches (5-7.5 cm) from the nearest of said holographic diffusion screens;
wherein diffuse beam of light has a spread of between 30°-65° from said lens.

19. The night vision illumination device of claim 19, wherein said laser diode produces light at 808 nm.

20. The night vision illumination device of claim 19, wherein said diffuse beam of light has a greater spreading in the horizontal than in the vertical.

21. A remotely operated robot with night vision capabilities comprising:
at least one camera system; and
at least one night vision illumination system;
wherein said night vision illumination system comprises:
at least one laser diode that produces a concentrated light beam in the 800 to 950 nm range;
a series of diffusion screens;
wherein said concentrated beam of light is directed at said series of diffusion screens, and wherein said series of diffusion screens diffuse said concentrated beam of light into a diffuse beam of light;
wherein said diffuse beam of light illuminates an area for said at least one camera.

22. The remotely operated robot of claim 21, wherein said night vision illumination system is integrally formed with said robot.

23. The remotely operated robot of claim 21, wherein said night vision illumination system is in a casing that is reversibly mounted to said robot.
